(19) United States
(12) Patent Application Publication
(10) Pub. No.: US 2022/0395938 A1
(43) Pub. Date: Dec. 15, 2022

(54) MILLING MACHINE AND METHOD OF SERVICING MACHINE COMPONENTS

(71) Applicant: Caterpillar Paving Products Inc., Brooklyn Park, MN (US)

(72) Inventor: Brian Joe Schlenker, Shoreview, MN (US)

(73) Assignee: Caterpillar Paving Products Inc., Brooklyn Park, MN (US)

(21) Appl. No.: 17/304,125

(22) Filed: Jun. 15, 2021

(51) Int. Cl. B23K 37/02; B23K 9/00; B23K 9/10; E01C 23/088

(52) U.S. Cl. CPC B23K 37/0294; B23K 9/0026; B23K 9/1006; E01C 23/088; B23K 2101/006

(57) ABSTRACT

A milling machine having a power source that generates an output power for performing one or more work operations. The milling machine also includes a rotor that receives a portion of the output power from the power source for operation thereof. The milling machine further includes a welding device disposed on the milling machine for servicing one or more machine components of the milling machine. The welding device is powered by the power source.

### TECHNICAL FIELD

The present disclosure relates to a milling machine and a method of servicing one or more machine components of the milling machine.

### BACKGROUND

Milling machines, such as cold planers, road reclaimers, pavement profilers, roadway planers, rotary mixers, and the like, are designed for scarifying, removing, mixing, or reclaiming material from a ground surface. Such milling machines typically have a rotor that may be mechanically, electrically, or hydraulically driven to accomplish one or more tasks. The rotor typically includes a number of cutting assemblies present on a drum of the rotor.

During operation, the rotors of these milling machines may get damaged by one or more obstructions present at a worksite. The obstructions may include rocks, metal pieces, concrete structures, and the like. Such obstructions may lead to failure of one or more components of the milling machines such as the rotor. For example, the obstructions may damage the cutting assemblies of the rotor. Such damages may have to be serviced in order to continue operations at the worksite. In some examples, a welding operation may have to be conducted for servicing the machine components. However, for performing the welding operation, either a service truck is required at the worksite or the milling machine may have to be relocated to a repair shop or a service center. Thus, a downtime and a repairing cost associated with the servicing may increase while reducing an efficiency of the milling machine.

U.S. Patent Application Number 2020/0023474 describes a number of modular panels for a vehicle mounted welding-type power system. A control panel transmits information to and receive information from a control device of the welding-type power system. A first power output panel provides the power to a welding-type tool, and a second power output panel provides power output to an auxiliary device. Each of the control panel, the first power output panel, and the second power output panel are in electrical communication with the welding-type power system, the control device controls the power output to the first and the second power output panels based on information from the control panel. Further, each of the control panel, the first power output panel, and the second power output panel are positioned at locations that are separate and remote from one another.

### SUMMARY OF THE DISCLOSURE

In one aspect of the present disclosure, a milling machine is provided. The milling machine includes a power source that generates an output power for performing one or more work operations. The milling machine also includes a rotor that receives a portion of the output power from the power source for operation thereof. The milling machine further includes a welding device disposed on the milling machine for servicing one or more machine components of the milling machine. The welding device is powered by the power source.

In another aspect of the present disclosure, a method of servicing one or more machine components of a milling machine is provided. The method includes generating, by a power source of the milling machine, an output power for performing one or more work operations. The method also includes disposing a welding device on the milling machine. The welding device is powered by the power source. The method further includes servicing the one or more machine components using the welding device.

Other features and aspects of this disclosure will be apparent from the following description and the accompanying drawings.

### BRIEF DESCRIPTION OF THE DRAWINGS

FIG. 1 illustrates a side view of a milling machine, according to examples of the present disclosure;

FIG. 2 is a block diagram illustrating a welding system associated with the milling machine of FIG. 1, according to examples of the present disclosure; and

FIG. 3 illustrates a flowchart for a method of servicing one or more machine components of the milling machine, according to examples of the present disclosure.

### DETAILED DESCRIPTION

Wherever possible, the same reference numbers will be used throughout the drawings to refer to the same or the like parts. Wherever possible, corresponding, or similar reference numbers will be used throughout the drawings to refer to the same or corresponding parts.

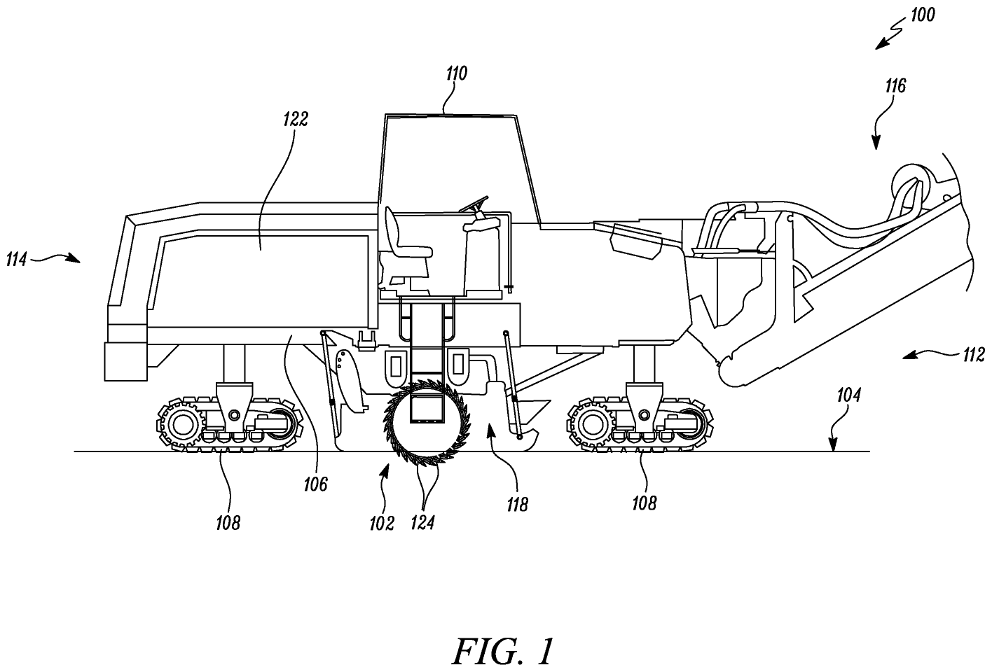

FIG. 1 illustrates an exemplary milling machine 100. The milling machine 100 includes a cold planer herein. Although shown as the cold planer, it may be understood that the milling machine 100 may alternatively include pavement profilers, road machines, roadway planers, rotary mixers, or any other suitable machine having a rotor 102 or a milling device (not shown) that may be used to scarify, remove, mix, or reclaim material from a surface 104 that may be made of bituminous or concrete and similar surfaces 104.

The milling machine 100 includes a frame 106. The milling machine 100 also includes a pair of track assemblies 108 for movement purposes and an operator cabin 110. The operator cabin 110 includes an operator interface (not shown) that enables an operator to control one or more machine operations. The milling machine 100 defines a first end 112 and a second end 114. The milling machine 100 also includes a conveyor assembly 116 disposed proximate the first end 112. The conveyor assembly 116 delivers material removed by the milling machine 100 to a receptacle (not shown). More particularly, the conveyor assembly 116 transports materials from a rotor chamber 118 to the receptacle.

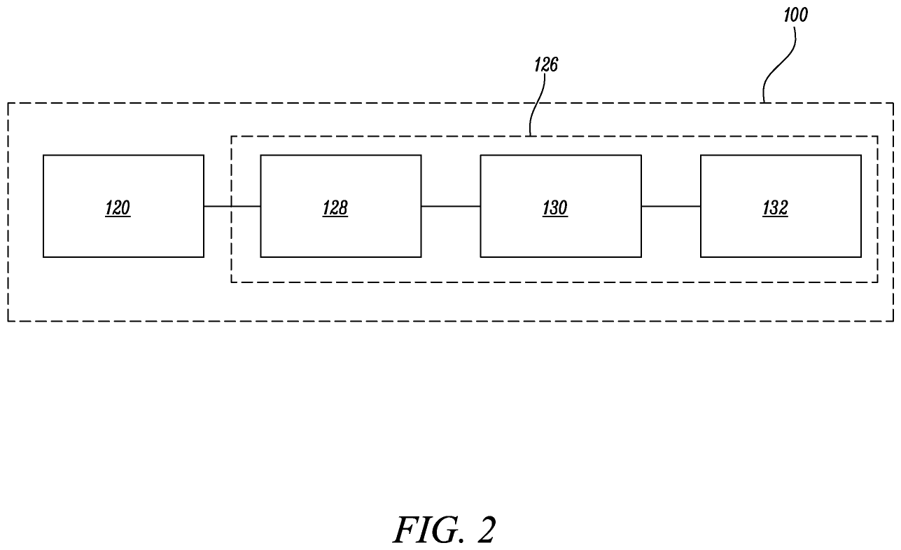

Further, the milling machine 100 includes a power source 120 (shown in FIG. 2) that generates an output power for performing one or more work operations. The power source 120 includes one or more of an engine, a battery, and a fuel cell. It should be noted that the power source 120 may include any type of prime mover, without limiting the scope of the present disclosure. In this example, the power source 120 includes the engine. The power source 120 may be an internal combustion engine. The power source 120 may include a gasoline engine, a diesel engine, a natural gas engine, and the like. The power source 120 may utilize any type of fuel to generate the output power such as a gasoline, a diesel, a compressed natural gas (CNG), a biofuel, and the like. The power source 120 may supply the output power for various machine operations and/or systems, such as a traction system, electronics, a hydraulic system, and the like. The power source 120 is operatively coupled to the track assemblies 108 for providing some portion of the output power to the track assemblies 108. The power source 120 is disposed within an enclosure 122 of the milling machine 100.

The milling machine 100 also includes the rotor 102 that receives a portion of the output power from the power source 120 for operation thereof. The rotor 102 performs operations such as scarifying, removing, mixing, or reclaiming material from the surface 104. The rotor 102 is rotatably mounted to the frame 106. The rotor 102 is disposed within the rotor chamber 118. The rotor 102 is disposed in the rotor chamber 118 such that the rotor 102 is exposed to the surface 104. The rotor 102 may include a number of cutting assemblies 124 mounted on a drum of the rotor 102. The cutting assemblies 124 contact with various types of surfaces during operation of the milling machine 100.

During operation, one or more machine components of the milling machine 100 may get damaged due to contact of such components with obstructions present at a worksite where the milling machine 100 is operating. For example, the rotor 102, and more specifically the cutting assemblies 124, may get damaged due to contact with rocks, metal pieces, concrete structure, or other obstructions that may be present on or under the surface 104. In order to continue operations at the worksite, the components of the milling machine 100 may have to be repaired or replaced, as per requirements.

Referring to FIG. 2, the milling machine 100 includes a welding system 126. The welding system 126 is disposed on the milling machine 100 to repair or replace the machine components of the milling machine 100. In the illustrated example, the welding system 126 includes a power drive assembly 128, an electric generation device 130, and a welding device 132.

The milling machine 100 includes the power drive assembly 128 disposed between the power source 120 and the electric generation device 130. The power drive assembly 128 transmits some portion of the output power from the power source 120 to the electric generation device 130. The power source 120 is operatively coupled to the power drive assembly 128. In one example, the power drive assembly 128 includes a mechanical drive (not shown). The mechanical drive includes one or more of a belt drive, a gear drive, a chain drive, and a rope and pulley drive. In an example, a rotating output shaft (not shown) of the power source 120 may be connected to the mechanical drive. Specifically, the output shaft from the power source 120 drives the mechanical drive.

In another example, the power drive assembly 128 includes a hydraulic drive (not shown). The hydraulic drive includes a pump and a motor. The electric generation device 130 may be driven by the pump or the motor, which are in turn operated by the power source 120. Specifically, the output shaft from the power source 120 drives the pump. The pump may include a hydraulic pump having an internal gear drive. The internal gear drive of the pump is coupled to the motor. Further, the motor includes a hydraulic motor, and the pump drives the motor for operation of the electric generation device 130 for generating electric power. It should be noted that the types of the power drive assembly 128 mentioned herein are exemplary in nature, and the milling machine 100 may include any other type of the power drive assembly 128, without limiting the scope of the present disclosure.

Further, the milling machine 100 includes the electric generation device 130 disposed between the power source 120 and the welding device 132. In some examples, the power drive assembly 128 may be integral with the electric generation device 130. The electric generation device 130 receives the portion of the output power from the power source 120. The electric generation device 130 generates and directs electric power to the welding device 132. Specifically, the electric generation device 130 is operatively coupled to the welding device 132 for servicing the machine components, such as the rotor 102 (see FIG. 1). The electric generation device 130 includes one or more of a generator (not shown) and an alternator (not shown).

In one example, the electric generation device 130 includes the generator to produce electric power. The electric generation device 130 may include an inline power generator or an integrated starter-generator. In an example, the generator may include a switched reluctance generator or any other type of generator. The generator may be operatively coupled to the power drive assembly 128. The generator converts the output power from the power source 120 into electric power, such as alternating current (AC) power or direct current (DC) power.

The generator may include a stator and an armature. The power drive assembly 128 rotates the armature of the generator. The rotation of the armature is relative to the stator of the generator. An electromagnetic interaction between a number of poles of the armature and the stator generates electric power, for instance, the AC power in one or more phases. The AC power is then communicated to an input of one or more power converters (not shown). The power converters convert, process, condition, regulate, or otherwise generate appropriate electric power. Specifically, the power converters supply the AC power to a charging circuit (not shown), which may employ a transformer, a rectifier, a regulator, and the like, to convert the AC power into suitable DC power, as per application requirements. The electric power is then supplied to the welding device 132.

In other examples, the electric generation device 130 includes the alternator to produce electric power. The alternator may include an automotive generator that generates the AC power, or any other type of alternator known in the art. The alternator may be operatively coupled to the power drive assembly 128. The alternator converts the output power from the power source 120 into electric power, specifically, into the AC power at a particular voltage and frequency. The alternator includes a stator and an armature. The power drive assembly 128 rotates the armature of the alternator. The rotation of the armature is relative to the stator of the alternator. A magnetic field of the armature cuts across the stator which in turn generates an induced electromotive force (EMF). The induced EMF then produces the AC power which is supplied to the welding device 132.

It should be noted that the types of the electric generation devices 130 described herein are exemplary in nature, and the milling machine 100 may include any other type of the electric generation device 130, without limiting the scope of the present disclosure. Further, in some examples, the electric generation device 130 may be present on the milling machine 100, such that the electric generation device 130 provides electric power to other machine components apart from the welding device 132. Alternatively, the welding system 126 may include a dedicated electric generation device, without any limitations.

Further, the welding device 132 is disposed on the milling machine 100 for servicing the one or more machine components of the milling machine 100. More particularly, the welding device 132 is disposed proximate the second end 114 (see FIG. 1) of the milling machine 100. In an example, the one or more machine components includes the rotor 102. It should be noted that the machine components may include any part of the milling machine 100 such as, the frame 106 (see FIG. 1), the conveyor assembly 116 (see FIG. 1), the track assemblies 108 (see FIG. 1), and the like, without limiting the scope of the present disclosure.

The welding device 132 is powered by the power source 120. More particularly, the output power generated by the power source 120 is converted into electric power by the electric generation device 130, which is then supplied to the welding device 132. Further, the welding device 132 is an arc welder. Alternatively, the welding device 132 may include a resistance welding device, a stud welding device, a laser welding device, and the like. It should be noted that the welding device 132 may include any other type of the welding device 132, without limiting the scope of the present disclosure.

In another example, the power source 120 includes the battery such that electric power stored in the battery is converted to motive power. For example, the machine 100 may include a battery powered machine. In this example, the battery and a motor may replace the engine such that the motor drives one or more systems of the machine 100, such as the hydraulic system of the machine 100. Further, a suitable power converting device, such as an inverter, may be disposed between the battery and the motor for supplying AC power to the motor.

The battery may include a lithium-ion battery, or any other type of battery used in automotive applications. A chemical energy stored in the battery may be converted into electric power based on an electrochemical reaction within the battery. An exemplary battery may provide 12 Volt (V), 24V, or 36 V of DC power, as per application requirements. The battery directly supplies electric power to the welding device 132. It should be noted that, in this example, the power drive assembly 128 and the electric generation device 130 may be eliminated as an output of the battery is electric power that is directly supplied to the welding device 132.

In other examples, the power source 120 may include the fuel cell. The fuel cell may include a hydrogen-oxygen fuel cell. Further, at an anode of the fuel cell, the hydrogen is oxidized to produce electrons and at a cathode of the fuel cell, oxygen is reduced. Production of electrons at the anode generates the EMF to produce electric power. The fuel cell directly supplies electric power to the welding device 132. It should be noted that, in this example, the power drive assembly 128 and the electric generation device 130 may be eliminated as an output of the fuel cell is electric power. It should be noted that the type of the power source 120 does not limit the scope of the present disclosure.

### INDUSTRIAL APPLICABILITY

The present disclosure relates to the milling machine 100 and a method 300 of servicing one or more machine components of the milling machine 100. The milling machine 100 includes the integral welding device 132 that provides a simple and cost-effective arrangement for repairing/replacing the machine components, such as the rotor 102 of the milling machine 100. Further, the integral welding device 132 does not require additional power sources for welding operations as the welding device 132 is powered by the power source 120 of the milling machine 100. Thus, the welding device 132 can be used for repairing or replacements of machine components at remote locations.

The integrated welding device 132 eliminates need of a service truck at the worksite or relocation of the milling machine 100 to a repair shop or a service center. This arrangement reduces a downtime of the milling machine 100 which, in turn, increases a productivity of the milling machine 100 at the worksite. Further, time and efforts required to relocate the milling machine 100 to the repair shop, or the service center can be eliminated.

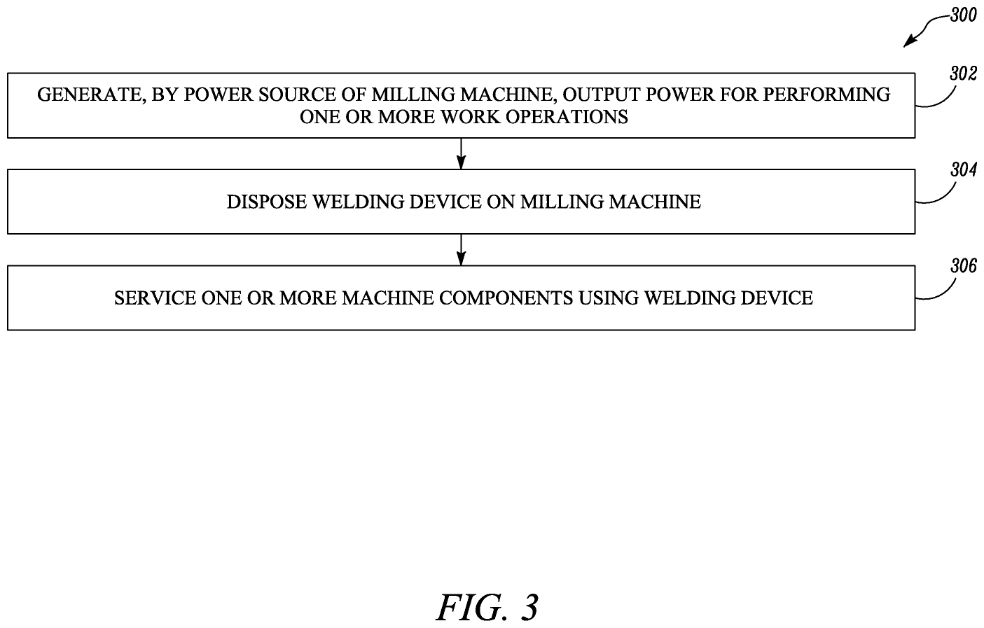

FIG. 3 illustrates a flowchart for the method 300 of servicing one or more machine components of the milling machine 100. At step 302, the power source 120 of the milling machine 100 generates the output power for performing one or more work operations. The power source 120 includes one or more of the engine, the battery, and the fuel cell.

At step 304, the welding device 132 is disposed on the milling machine 100. The welding device 132 is powered by the power source 120. Specifically, the welding device 132 is the arc welder. Further, the electric generation device 130 disposed between the power source 120 and the welding device 132 receives the portion of the output power from the power source 120. The electric generation device 130 generates and directs electric power to the welding device 132. The electric generation device 130 includes one or more of the generator and the alternator. Further, the output power from the power source 120 is directed to the electric generation device 130 via the mechanical drive or the hydraulic drive. The mechanical drive includes one or more of the belt drive, the gear drive, the chain drive, and the rope and pulley drive. The hydraulic drive includes the pump and the motor. At step 306, the one or more machine components are serviced using the welding device 132. In some examples, the rotor 102 of the milling machine 100 is serviced using the welding device 132.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A milling machine comprising:
a power source that generates an output power for performing one or more work operations;
a rotor that receives a portion of the output power from the power source for operation thereof; and
a welding device disposed on the milling machine for servicing one or more machine components of the milling machine, wherein the welding device is powered by the power source.

2. The milling machine of claim 1 further comprising an electric generation device disposed between the power source and the welding device, the electric generation device receives a portion of the output power from the power source, wherein the electric generation device generates and directs electric power to the welding device.

3. The milling machine of claim 2, wherein the electric generation device includes at least one of a generator and an alternator.

4. The milling machine of claim 2 further comprising a power drive assembly disposed between the power source and the electric generation device.

5. The milling machine of claim 4, wherein the power drive assembly includes a mechanical drive.

6. The milling machine of claim 5, wherein the mechanical drive includes at least one of a belt drive, a gear drive, a chain drive, and a rope and pulley drive.

7. The milling machine of claim 4, wherein the power drive assembly includes a hydraulic drive.

8. The milling machine of claim 7, wherein the hydraulic drive includes a pump and a motor.

9. The milling machine of claim 1, wherein the power source includes at least one of an engine, a battery, and a fuel cell.

10. The milling machine of claim 1, wherein the one or more machine components includes the rotor.

11. The milling machine of claim 1, wherein the welding device is an arc welder.

12. A method of servicing one or more machine components of a milling machine, the method comprising:
generating, by a power source of the milling machine, an output power for performing one or more work operations;
disposing a welding device on the milling machine, wherein the welding device is powered by the power source; and
servicing the one or more machine components using the welding device.

13. The method of claim 12 further comprising receiving, by an electric generation device disposed between the power source and the welding device, a portion of the output power from the power source, wherein the electric generation device generates and directs electric power to the welding device.

14. The method of claim 13, wherein the electric generation device includes at least one of a generator and an alternator.

15. The method of claim 13 further comprising directing the output power from the power source to the electric generation device via at least one of a mechanical drive and a hydraulic drive.

16. The method of claim 15, wherein the mechanical drive includes at least one of a belt drive, a gear drive, a chain drive, and a rope pulley drive.

17. The method of claim 15, wherein the hydraulic drive includes a pump and a motor.

18. The method of claim 12, wherein the power source includes at least one of an engine, a battery, and a fuel cell.

19. The method of claim 12 further comprising servicing a rotor of the milling machine using the welding device.

20. The method of claim 12, wherein the welding device is an arc welder.
